(19) United States
(12) Patent Application Publication
(10) Pub. No.: US 2020/0248873 A1
(43) Pub. Date: Aug. 6, 2020

(54) VALVE ASSEMBLIES AND FLUID STORAGE AND DISPENSING PACKAGES COMPRISING SAME

(71) Applicant: ENTEGRIS, INC., Billerica, MA (US)

(72) Inventors: Daniel ELZER, Gilbert, AZ (US); Ying TANG, Brookfield, CT (US); Barry L. CHAMBERS, Midlothian, VA (US); Joseph D. SWEENEY, New Milford, CT (US); Shaun M. WILSON, Trumbull, CT (US); Steven E. BISHOP, Corrales, NM (US); Steven ULANECKI, Oxford, CT (US); James V. MCMANUS, Bethel, CT (US); Oleg BYL, Southbury, CT (US); Christopher SCANNELL, Middlebury, CT (US); Edward E. JONES, Woodbury, CT (US); Joseph R. DESPRES, Middletown, CT (US)

(21) Appl. No.: 16/855,684

(22) Filed: Apr. 22, 2020

Related U.S. Application Data
(63) Continuation of application No. 15/573,020, filed on Nov. 9, 2017.
(60) Provisional application No. 62/160,409, filed on May 12, 2015.

(51) Int. Cl. F17C 13/04; F17C 11/00

(52) U.S. Cl. CPC F17C 13/04; F17C 11/00; F17C 2205/0391; F17C 2205/0338; F17C 2205/0335; F17C 2201/058; F17C 2201/0114; F17C 2205/0329; F17C 2201/0119; F17C 2205/0385; F17C 2203/0617; F17C 2205/0308

(57) ABSTRACT

Fluid dispensing assemblies are disclosed, for use in fluid supply packages in which such fluid dispensing assemblies as coupled to fluid supply vessels, for dispensing of fluids such as semiconductor manufacturing fluids. The fluid dispensing assemblies in specific implementations are configured to prevent application of excessive force to valve elements in the fluid dispensing assemblies, and/or for avoiding inadvertent or accidental open conditions of vessels that may result in leakage of toxic or otherwise hazardous or valuable gas. Also described are alignment devices for assisting coupling of coupling elements, e.g., coupling elements of fluid supply packages of the foregoing type, so that damage to such couplings as a result of misalignment is avoided.

### CROSS-REFERENCE TO RELATED APPLICATION

The benefit under 35 USC 119 of U.S. Provisional Patent Application 62/160,409 filed May 12, 2015 for “Valve Assemblies and Fluid Storage and Dispensing Packages Comprising Same” is hereby claimed. The disclosure of U.S. Provisional Patent Application 62/160,409 is hereby incorporated herein by reference, in its entirety, for all purposes.

### FIELD

The present disclosure relates to valve assemblies and to fluid storage and dispensing packages.

### DESCRIPTION OF THE RELATED ART

In the use of fluid storage and dispensing packages including fluid storage and dispensing vessels coupled with valve head assemblies, the valve head assembly contains a flow control valve that is translatable within the valve head structure, between fully open and fully closed positions. The position of the valve is effected by a hand wheel that is manually rotatable to adjust the valve, or alternatively by means of a valve actuator, such as a pneumatic valve actuator that controls the position of the valve in the valve assembly.

Fluid storage and dispensing packages of such type include packages commercially available under the SDS and SAGE trademarks from Entegris, Inc. (Billerica, Mass., USA) in which fluid is stored on an adsorbent medium, from which it is desorbed under dispensing conditions, and packages commercially available under the VAC trademark from Entegris, Inc. in which the fluid storage and dispensing vessel contains an interiorly disposed pressure regulator assembly arranged to open in response to a downstream pressure below the set point of the regulator assembly, so that fluid is dispensed at the set point pressure. Other fluid storage and dispensing packages with interiorly positioned pressure regulating components include packages commercially available under the trademark UPTIME from Praxair, Inc. (Danbury, Conn., USA).

In fluid supply packages of the foregoing types, the provision of a manually operated hand wheel or other manual valve adjustment member entails risk that excessive manual force can be exerted on the valve adjustment member in attempting to open or close the valve, which in extreme cases can result in damage to the valve seat or ceiling surface of the valve in the valve head, or can cause the valve stem of the valve in the valve head to break. In other instances, the operator may not be aware of whether the manual valve adjustment member is in an open or closed position, which also entails the risk of adverse gas release events or other undesired consequences. For example, a valve may be opened so hard that an operator, believing it to be closed, may remove the fluid supply package associated with such valve from a tool in which the fluid supply packages employed, and as such removal may result in gas release from the fluid supply package having the fluid dispensing valve in an open position.

In fluid supply packages in which fluid is adsorptively stored on and desorptively dispensed from an adsorbent storage medium, the fluid supply package as a result of such adsorbent storage medium may exhibit an extremely low catastrophic release rate of gas in the event of a breach of the vessel containing the adsorbent having the fluid adsorbed thereon, since the attendant desorptive release will be very slow in comparison to egress of fluid from a conventional high-pressure gas cylinder under vessel failure conditions. Nonetheless, the adsorbent-based fluid storage and dispensing package can still slowly leak gas through the outlet port of the package if the flow control valve in the valve head assembly of the package is mistakenly or inadvertently left open. In instances where the adsorbed gas is of a toxic or otherwise hazardous character, such leakage may pose a serious health and safety risk, e.g., where the gas is a flammable hydride gas.

Fluid supply packages of the above-discussed types may in applications such as semiconductor manufacturing involve many hazardous gases. In instances in which the fluid dispensing assembly of the fluid supply package is capped with a valve head dust cap, e.g., a VCR cap or similar fitting, relatively small amounts of gas may be released when the valve head dust cap is removed. The reasons for this may include cross-valve leak, accidental partial opening of the cylinder valve during shipment/handling, etc. Although the rates involved are typically very small (less than a few sccm), the presence of any material is potentially dangerous, since the threshold limit values (8-hr exposure levels) for the materials being used are often less than 10 ppm. In fact, in the case of arsine, TLV is reported as 50 ppb. In addition to the toxic nature of materials being used, some materials are pyrophoric and will burn immediately in an air environment without the need for a spark. For these reasons, material build-up in the dust cap presents a significant hazard.

Another issue encountered in the use of fluid supply packages is damage to sealing surfaces or cross-threading of the fittings.

Fluid supply packages of a type incorporating adsorbent as a fluid storage medium in the fluid supply vessel are also susceptible to temperature effects. In an excess temperature condition of the fluid supply package, the adsorbent will be heated, and will correspondingly release previously adsorbed fluid. If the temperature excursion is substantial, the resulting pressure increase may result in leakage of fluid from the over-pressured vessel through seals and fluid discharge port of the fluid dispensing assembly.

All of the foregoing issues limit the use and applicability of fluid supply packages. In consequence, the art continues to seek improvements in fluid supply packages, to provide safe, reliable and economic package configurations that address such issues.

### SUMMARY

The present disclosure relates to valve assemblies and to fluid storage and dispensing packages.

In one aspect, the disclosure relates to a fluid dispensing assembly for use in a fluid supply package in which the fluid dispensing assembly is coupled with a fluid supply vessel, the fluid dispensing assembly comprising a valve head including a fluid dispensing valve in a valve chamber therein, with a dispensed fluid flow path in the valve head including a valve head inlet passage communicating with the valve chamber and with the fluid supply vessel when the fluid dispensing assembly is engaged therewith, and a fluid discharge passage communicating with the valve chamber and with a discharge port in the valve head, the fluid discharge passage defining a throat of the discharge port, and a leak preventer valve assembly configured to prevent fluid leakage from the fluid supply vessel through the discharge port to an ambient environment of a corresponding fluid supply package.

In another aspect, the disclosure relates to a fluid dispensing assembly for use in a fluid supply package in which the fluid dispensing assembly is coupled with a fluid supply vessel, the fluid dispensing assembly comprising a valve head including a fluid dispensing valve in a valve chamber therein communicating with valve head inlet and outlet passages, an actuator configured to translate the fluid dispensing valve between a fully closed and a fully open position, and a positional indicator configured to generate an output indicative of a closed or open condition of the fluid dispensing valve in the valve chamber.

In a further aspect, the disclosure relates to a fluid dispensing assembly for use in a fluid supply package in which the fluid dispensing assembly is coupled with a fluid supply vessel, the fluid dispensing assembly comprising a valve head including a fluid dispensing valve in a valve chamber therein communicating with the valve head inlet and outlet passages, an actuator configured to translate the fluid dispensing valve between a fully closed to a fully open position, and a positional limiter configured to prevent the actuator from exerting force on the fluid dispensing valve beyond the force required for effecting a fully closed or fully open condition in respective closing or opening operations of the fluid dispensing valve in the valve chamber.

A further aspect of the disclosure relates to a fluid dispensing assembly for use in a fluid supply package in which the fluid dispensing assembly is coupled with a fluid supply vessel, the fluid dispensing assembly comprising a valve head including a fluid dispensing valve in a valve chamber therein communicating with valve head inlet and outlet passages, an actuator configured to translate the fluid dispensing valve from a fully closed to a fully open position, and a lock assembly configured to secure the fluid dispensing valve in the valve chamber in a fully closed condition when not in dispensing operation.

A still further aspect of the disclosure relates to a fluid dispensing assembly for use in a fluid supply package in which the fluid dispensing assembly is coupled with a fluid supply vessel, the fluid dispensing assembly comprising a valve head including a fluid dispensing valve in a valve chamber therein communicating with valve head inlet and outlet passages, an actuator configured to translate the fluid dispensing valve between a fully closed and a fully open position, and a torque wrench integrated and operatively engageable with the actuator, the torque wrench disengaging once a set closing torque is achieved, and optionally being configured to provide an audible output signal, e.g., in the manner of a gas cap that ‘clicks’ and disengages once a set closing torque is achieved.

Another aspect of the disclosure relates to a fluid dispensing assembly for use in a fluid supply package in which the fluid dispensing assembly is coupled with a fluid supply vessel, the fluid dispensing assembly comprising a valve head including a fluid dispensing valve in a valve chamber therein communicating with valve head inlet and outlet passages, an actuator configured to translate the fluid dispensing valve between a fully closed and a fully open position, a cap configured to overlie the valve head and define therewith an enclosed volume, and adsorbent disposed in the enclosed volume and arranged to remove contaminating fluid leaking from the valve head into the enclosed volume.

In another aspect, the disclosure relates to a coupling alignment device including a body portion adapted to circumscribe respective coupling elements to be engaged with one another so that the coupling elements are axially aligned for engagement, and a positioning assembly operatively associated with the body portion and configured to position the coupling alignment device upon or subsequent to engagement of the respective coupling elements.

In yet another aspect, the disclosure relates to a fluid supply package comprising a fluid dispensing assembly of the present disclosure, as variously described herein.

A further aspect of the disclosure relates to a pressure-regulated fluid supply package including a vessel to which is coupled a fluid dispensing assembly including a discharge port for dispensing fluid from the vessel, with the vessel containing in an interior volume thereof an interior fluid delivery assembly configured to deliver fluid from the vessel to the fluid dispensing assembly for dispensing of fluid from the package at the discharge port, the interior fluid delivery assembly defining a fluid flow path and including at least one device configured to regulate flow of the fluid from the vessel to the discharge port, said device opening to fluid flow in response to pressure in the flow path downstream of the device that is below a set point pressure of the device, and at least one check valve upstream and/or downstream of the device, configured to prevent leakage of fluid through the device.

Another aspect of the disclosure relates to a fluid supply package of a type as variously described herein, wherein the fluid supply vessel contains a fluid.

A further aspect of the disclosure relates to a semiconductor manufacturing apparatus, comprising a fluid supply package as variously described herein.

Another aspect of the disclosure relates to a method of providing fluid for use, comprising packaging a fluid in a fluid supply package of a type as variously described herein.

The disclosure in a further aspect relates to a method of providing fluid for use, comprising supplying the fluid for use in a fluid supply package of a type as variously described herein.

Other aspects, features and embodiments of the disclosure will be more fully apparent from the ensuing description and appended claims.

### BRIEF DESCRIPTION OF THE DRAWINGS

FIG. 1 is a perspective view of a fluid supply package according to one embodiment of the present disclosure.

FIG. 2 is a perspective view of a fluid dispensing assembly of a type that may be deployed with the fluid supply package of FIG. 1.

FIG. 3 is a schematic perspective view of a leak preventer valve assembly.

FIG. 4 is a cross-sectional elevation view of a fluid dispensing assembly of a type as may be employed in the fluid supply package of FIG. 1, showing installation positions for the leak preventer valve assembly.

FIG. 5 is a perspective view of an upper portion of a fluid supply package of the type shown in FIG. 1, and a torque wrench integrated with the hand wheel of the fluid dispensing assembly, with a torque limit indicator display.

FIG. 6 is an elevation view, in partial section, of a fluid storage and dispensing system utilizing a monolithic sorbent, according to a further aspect of the disclosure.

FIG. 7 is a partial sectional side elevation view of a coupling alignment device according to one aspect of the disclosure, as associated with couplings to be engaged with one another.

FIG. 8 is a partial sectional side elevation view of the coupling alignment device and couplings of FIG. 7, when the couplings have been fully engaged with one another.

FIG. 9 is a perspective view of a coupling alignment device according to a further embodiment, as associated with couplings engaged with the assistance of such device.

FIG. 10 is a perspective view, in partial section, of a pressure-regulated fluid supply package in accordance with one aspect of the present disclosure.

### DETAILED DESCRIPTION

The present disclosure relates to valve assemblies and to fluid storage and dispensing packages.

In various aspects, the disclosure relates to a fluid dispensing assembly for use in a fluid supply package in which the fluid dispensing assembly is coupled with a fluid supply vessel, the fluid dispensing assembly comprising a valve head including a fluid dispensing valve in a valve chamber therein, with a dispensed fluid flow path in the valve head including a valve head inlet passage communicating with the valve chamber and with the fluid supply vessel when the fluid dispensing assembly is engaged therewith, and a fluid discharge passage communicating with the valve chamber and with a discharge port in the valve head, the fluid discharge passage defining a throat of the discharge port, and a leak preventer valve assembly configured to prevent fluid leakage from the fluid supply vessel through the discharge port to an ambient environment of a corresponding fluid supply package.

In such fluid dispensing assembly, the leak preventer valve assembly may be disposed: (i) in the throat of the discharge port, (ii) at the discharge port, (iii) in the valve head in the inlet passage or discharge passage thereof, or (iv) in a dispensing conduit communicating with the valve head inlet passage and extending into an interior volume of a fluid supply vessel coupled with the fluid dispensing assembly in a corresponding fluid supply package.

In various embodiments, the leak preventer valve assembly comprises at least one check valve.

Thus, in one aspect, the disclosure relates to a fluid supply package in which a small check valve is disposed in the throat of the discharge port of the fluid dispensing assembly of the package. The check valve thus functions as a leakage preventer device, and keeps gas from inadvertently diffusing or otherwise leaking from the vessel and posing a hazard.

The leakage preventer device is normally closed and put in place after the vessel of the fluid supply package is filled. After use, i.e., after the fluid in the fluid supply vessel has been dispensed and the vessel has been exhausted to a predetermined extent, the leakage preventer device can be removed to enable the fluid supply vessel to be refilled. Thus, the leakage preventer device may be inexpensive in character, and may in fact be a disposable accessory for the fluid supply package.

In applications in which vacuum is applied on the fluid supply package, e.g., in an ion implantation system manifold coupled to the fluid supply package, the leakage preventer device would be configured to open and accommodate flow of fluid from the fluid supply vessel to the fluid dispensing assembly, for discharge at the fluid discharge port of the package. For such purpose, the leakage preventer device is designed with appropriate flow conductance so that it does not restrict flow in dispensing operation of the fluid supply package.

The leakage preventer device may have particular utility in warm climates and at significant elevations at which atmospheric pressure is low, where the fluid supply package is susceptible to being warmed in elevated temperature ambient conditions to sufficiently high temperatures to mediate leakage of fluid from the vessel to the low atmospheric pressure environment of the package.

The presence of the leakage preventer device also enables ventilation rates in the area in which the fluid supply package is installed to be reduced beyond normal worse case release (WCR) conditions, e.g., in gas cabinets in which the volumetric flow rate of the sweep gas may be reduced without increasing risk attendant the use of the fluid supply package.

The leakage preventer device may comprise a check valve associated with a pressure regulator interiorly disposed in a fluid supply vessel of the fluid supply package, so that the vessel is interiorly pressure-regulated. Vessels of such type are commercially available from Entegris, Inc. (Billerica, Mass., USA) under the trademark VAC, and may include one or more pressure regulator devices in the interior volume of the vessel. The check valve in the leak preventer arrangement may be before and/or after the pressure regulator device(s) in the dispensed gas flow path, i.e., upstream and/or downstream of such interiorly located regulator(s). While regulators prevent backflow most of the time, there is a period when the gas supply vessel pressure is less than the regulator set point (when the gas supply vessel is near empty) when backflow could occur. The check valve eliminates this possibility.

The foregoing approach is also applicable to vacuum actuated dispensing valves in the interior volume of the gas supply vessel, to provide a check valve/vacuum actuated dispensing valve assembly with one or more check valves associated with the vacuum actuated dispensing valve to prevent backflow or other undesired performance behavior of the vacuum actuated dispensing valve interiorly disposed in the gas supply vessel.

By way of specific example, a gas supply vessel may be provided with an interiorly disposed regulator that normally delivers gas at 500 torr. A check valve is provided downstream of the regulator, inside the gas supply vessel. This check valve may for example have a cracking pressure of 300 torr. In normal use, the gas supply vessel may deliver gas at approximately 200 torr. However, in the event that the regulator creeps, the check valve will ensure that no leak occurs up until a certain point, which in this case would be about 760 torr+300 torr=1060 torr. Accordingly, the combination of a check valve with the regulator will rigorously require vacuum for flow actuation and will eliminate any occurrence of back-flow, even when the gas supply vessel is near empty. If the regulator were to creep above 1060 torr delivery pressure, then the pressure-regulated vessel would no longer be vacuum-actuated in character, but the check valve and regulator assembly would still serve to reduce the potential release rate.

Accordingly, the disclosure relates in one aspect thereof to a pressure-regulated fluid supply package including a vessel to which is coupled a fluid dispensing assembly including a discharge port for dispensing fluid from the vessel, with the vessel containing in an interior volume thereof an interior fluid delivery assembly configured to deliver fluid from the vessel to the fluid dispensing assembly for dispensing of fluid from the package at the discharge port, the interior fluid delivery assembly defining a fluid flow path and including at least one device configured to regulate flow of the fluid from the vessel to the discharge port, said device opening to fluid flow in response to pressure in the flow path downstream of the device that is below a set point pressure of the device, and at least one check valve upstream and/or downstream of the device, configured to prevent leakage of fluid through the device.

The devices in the above-described pressure-regulated fluid supply package may comprise pressure regulators with fixed set points or adjustably settable set points, and the interior fluid dispensing assembly may include one, two, or more of such devices, at least one of which has at least one check valve associated therewith, upstream and/or downstream of the device in the flow path defined by the interior fluid dispensing assembly.

Alternatively, the devices in the above-described pressure-regulated fluid supply package may comprise so-called vacuum-actuated valves, such as are employed in fluid supply packages commercially available from Praxair, Inc., Danbury, Conn., USA under the trademark UPTIME. Such devices may alternatively be of still other types.

The disclosure in a further aspect relates to open valve leak prevention of a fluid dispensing assembly valve, e.g., where the fluid dispensing assembly is coupled with a fluid storage and dispensing vessel and the fluid dispensing assembly is arranged for selective dispensing of fluid from the vessel. The open valve leak prevention arrangement includes a fluid dispensing assembly including a valve head including an internal valve volume in which is disposed a flow control valve. The internal valve volume communicates with a fluid outlet port of the valve head. A dual flow control valve is coupled to the outlet port. For example, the fluid dispensing assembly may include an outlet port defining a 0.25 inch (0.635 cm) or 0.5 inch (1.27 cm) VCR connection.

The dual flow control valve may for example be constructed with a VCR connection on each end, enabling the dual flow control valve to be removed when needed. The dual flow control valve can be configured in a single, or alternatively a double, back-to-back configuration, and may function in a manner analogous to a set point gas pressure regulator, albeit without gas pressure regulating capability. The dual flow control valve may comprise a pressure sensing assembly that can be set to actuate at 650 torr, or other set point pressure. The dual flow control valve may be deployed in the manner of an in-line cartridge filter, and may be of a disposable character.

The dual flow control valve in such arrangement prevents leakage through the valve seat of the valve in the fluid dispensing assembly, when such fluid dispensing assembly valve is mistakenly or inadvertently left open or there is a valve seat leak of the valve in the fluid dispensing assembly.

In various embodiments, the dual flow control valve may be deployed as a component of a gas dispensing “stick” arranged to downwardly extend into the interior volume of the associated fluid storage and dispensing vessel, as a gas discharge conduit for discharging fluid from the vessel under dispensing conditions. The dual flow control valve for such purpose may as mentioned above be deployed in the matter of an in-line cartridge filter in such gas discharge conduit. In instances in which the fluid storage and dispensing vessel contains adsorbent in a monolithic form, e.g., in a stack of cylindrical carbon adsorbent pucks or discs, as described in U.S. Pat. No. 8,002,880 issued Aug. 23, 2011 to J. Donald Carruthers, the adsorbent articles may be shaped to accommodate the dual flow control valve as an in-line component of the gas dispensing tube. Thus, the stacked adsorbent articles shown in such patent may be provided with enlarged central openings through which the gas dispensing tube containing the dual flow control valve extends in such stacked array of adsorbent articles.

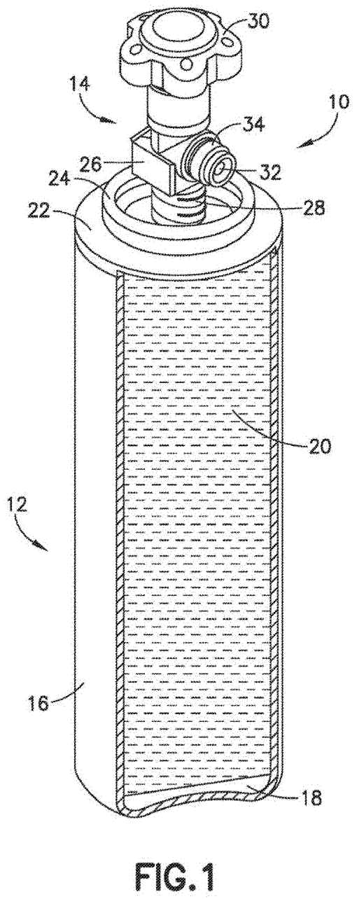

Referring to the drawings, FIG. 1 is a perspective view of a fluid supply package according to one embodiment of the present disclosure, in which the aforementioned leak prevention approaches can be employed.

FIG. 1 shows a fluid supply package 10 including a fluid storage and dispensing vessel 12 and a fluid dispensing assembly 14. The vessel 12 includes a cylindrical vessel wall 16 which together with the for the vessel defines an interior volume 18 of the vessel, in which is disposed adsorbent material in the form of a stacked array of disk-shaped adsorbent articles, as described in the aforementioned U.S. Pat. No. 8,002,880.

The fluid supply package includes a top closure member 22 that is secured to the cylindrical vessel wall 16, such as by brazing, welding, mechanical fastening, or other means of securement. The top closure member has a cylindrical collar circumscribing an opening in which is disposed a valve body coupling section 28 of the fluid dispensing assembly 14. For such purpose, the valve body coupling section may be threaded for engagement with a threaded opening in the top closure member 22.

The fluid dispensing assembly 14 includes a valve head 26 in which is disposed a flow control valve element that is translatable between fully open and fully closed positions by corresponding manual rotation of the hand wheel 30. The flow control valve element (not shown in FIG. 1) is disposed in a valve chamber in the valve head 26, and the valve chamber (likewise not shown in FIG. 1) is in flow communication when the valve is at least partially open with the fluid dispensing outlet port 30 to at the end of the fluid dispensing outlet conduit 34.

In another aspect, the disclosure relates to a fluid dispensing assembly for use in a fluid supply package in which the fluid dispensing assembly is coupled with a fluid supply vessel, the fluid dispensing assembly comprising a valve head including a fluid dispensing valve in a valve chamber therein communicating with valve head inlet and outlet passages, an actuator configured to translate the fluid dispensing valve between a fully closed and a fully open position, and a positional indicator configured to generate an output indicative of a closed or open condition of the fluid dispensing valve in the valve chamber.

The actuator may be manual or automatic (pneumatic, electrical, etc.) in character, and may for example include a manual actuator that is mechanically coupled with the fluid dispensing valve, e.g., by a valve stem, with the actuator configured for rotation to translate the fluid dispensing valve between fully open and fully closed positions. As another example, the fluid dispensing valve may be of a flip-type, in which a manual or automatic flip actuator is employed to translate the fluid dispensing valve between the fully open and fully closed positions. The actuator alternatively may be of any other suitable type that is effective to translate a valve element in the fluid dispensing assembly between fully open and fully closed positions.

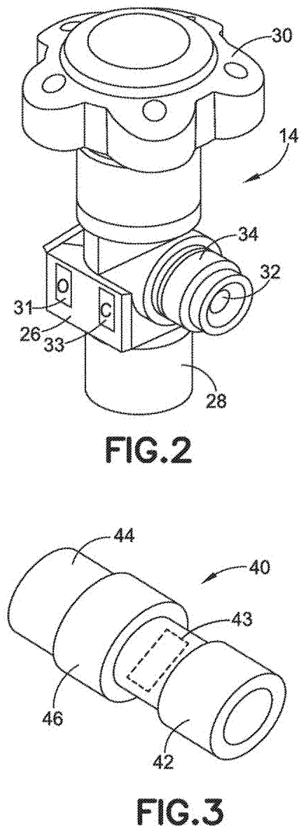

FIG. 2 is a perspective view of a fluid dispensing assembly of a type that may be deployed with the fluid supply package of FIG. 1. Corresponding parts and features are numbered correspondingly to those of FIG. 1.

In accordance with one embodiment of the disclosure, the valve head 26 may be equipped with an open indicator display 31 and a closed indicator display 33, which respectively indicate the corresponding open or closed character of the flow control valve in the fluid dispensing assembly 14. For such purpose, the hand wheel 30 is operatively coupled with a position-responsive mechanism that is configured so that when the hand wheel is in a position corresponding to a fully closed condition of the valve in the valve head 26, the closed indicator display 33 is illuminated to reflect such fully closed condition of the valve, and, correspondingly, when the valve is at least partially open, the closed indicator display 33 is non-illuminated, and the open indicator display 31 is illuminated to reflect that the valve is at least partially open.

In this manner, a readily visually ascertainable indication of the fully closed or at least partially open condition of the valve is indicated to a person viewing the fluid supply package. In such manner, the person viewing the fluid supply package is readily apprised of the status of the valve in the valve head.

In lieu of a selectively illuminated open/closed indicator arrangement, a single window can be provided on the valve head, with rotation of the hand wheel 30 serving to mechanically display in the window a corresponding open or closed indication depending on the specific position of the valve that has been translated by the hand wheel. Any other mechanical, electromechanical, optical, or other indicator system may be employed that is positionally dependent on the degree of rotation and direction of rotation of the hand wheel 30 to indicate the corresponding open or closed status of the valve in the valve head.

Other open/closed indicators could be employed with the fluid dispensing assembly, to identify the closed or (at least partially) open condition of the valve in the fluid dispensing assembly. Thus, labels, alphabetic or numeric displays (e.g., a numeric indicator of the degree of open character of the valve, from 0% (fully closed) to 100% (fully open)), or colors that become visible when the hand wheel is rotated may be employed. In other embodiments, pop-up indicators showing open or closed condition of the valve may be employed. As another alternative, the hand wheel can be attached to the stem in such manner as to allow the position of the indicator on the hand wheel to be indexed or aligned to the valve outlet to indicate the position of the valve.

In a specific embodiment, the valve stem may be constructed and arranged to limit the rotation of the valve to a predetermined extent, e.g., one quarter turn of a ball valve, to assist in the determination of the positional state of the valve.

In a further aspect, the disclosure relates to a fluid dispensing assembly for use in a fluid supply package in which the fluid dispensing assembly is coupled with a fluid supply vessel, the fluid dispensing assembly comprising a valve head including a fluid dispensing valve in a valve chamber therein communicating with the valve head inlet and outlet passages, an actuator configured to translate the fluid dispensing valve between a fully closed to a fully open position, and a positional limiter configured to prevent the actuator from exerting force on the fluid dispensing valve beyond the force required for effecting a fully closed or fully open condition in respective closing or opening operations of the fluid dispensing valve in the valve chamber.

In such fluid dispensing assembly, the positional limiter may comprise a torque limiter.

In another aspect, the disclosure relates to a fluid dispensing assembly for use in a fluid supply package in which the fluid dispensing assembly is coupled with a fluid supply vessel, the fluid dispensing assembly comprising a valve head including a fluid dispensing valve in a valve chamber therein communicating with valve head inlet and outlet passages, an actuator configured to translate the fluid dispensing valve from a fully closed to a fully open position, and a lock assembly configured to secure the fluid dispensing valve in the valve chamber in a fully closed condition when not in dispensing operation.

In other embodiments, a lock or other securement structure can be employed to secure the valve of the fluid dispensing assembly in a closed position when the fluid supply package is not in use, such as when it is in storage or being transported. In general, the valve in the fluid dispensing assembly needs to be closed at all times except when in use to dispense fluid to a tool or other end-use apparatus, environment, or application. A safety interlock can be used to ensure that the valve in the fluid dispensing assembly is fully closed and can only be opened when the associated fluid supply package is connected to a tool or gas fill installation for respective dispensing or filling operations. Such safety interlock also ensures that the valve in the fluid dispensing assembly is fully closed when it is necessary to remove the fluid supply package from the tool.

The safety interlock can be of a mechanical, pneumatic, or other suitable character, as appropriate to a specific implementation.

In a mechanical configuration, the safety interlock may employ a mechanical pin/key to lock the valve in the fluid dispensing assembly so that it cannot be opened when the fluid dispensing assembly is not connected to a tool or gas line. When the fluid supply package is connected to a flow circuit, e.g., a pigtail, or a gas line, the pigtail or gas line fitting may operate to deploy a pin or key to push the fluid supply package lock pin and releases it, so that the fluid supply package valve in the fluid dispensing assembly can be opened while the fluid supply package is connected to the tool. Meanwhile, while the fluid supply package is connected to the tool and the valve in the fluid dispensing assembly is in an open position, the fluid supply package and flow circuit will be locked as well, so that the fluid supply package cannot be disconnected from the tool unless the valve in the fluid dispensing assembly is closed. Such mechanical interlock design can be combined with any label, sign, indicator, or display on the fluid supply vessel or fluid dispensing assembly.

A pressure-responsive safety interlock can be configured in a manner analogous to that of the mechanical interlock, but so that it is driven by pressure instead of a mechanical key. An interlock valve may be provided inside the fluid dispensing assembly, so that the valve is at a normal position that locks the fluid dispensing assembly valve in a closed position at atmospheric pressure. When the fluid supply package is installed on a tool and a fluid discharge line is evacuated by pumping to a vacuum pressure level, the valve will be pushed and release the lock so that the fluid dispensing assembly valve can be opened. Meanwhile, it may optionally push another locking element or assembly to lock the fluid dispensing line connection so that the fluid supply package cannot be removed from the fluid dispensing line.

Such pressure interlock may be utilized with a mechanical interlock or any label, sign, indicator, or display on the fluid supply package or fluid dispensing assembly.

In various embodiments, the fluid dispensing assembly may employ a valve outlet that is configured so that the fluid dispensing assembly valve of the fluid supply package can only be opened to enable dispensing when the fluid supply package is connected to a correct mating fitting at the valve outlet, i.e., fluid dispensing port, of the fluid supply package.

As indicated earlier herein, and integrated torque limiting device can be provided in or in connection with the valve of the fluid dispensing assembly, such that a user is prevented from applying too much force when opening or closing the valve.

In some embodiments, integrating pneumatic actuators with fluid dispensing assembly valves can eliminate operator error that can damage the valve when it is being opened or closed. In these or other embodiments, the pneumatic actuator can be integrated with the tool to which fluid is being supplied by the fluid supply package, so that the fluid dispensing valve is shut by actuation of the pneumatic actuator in the event that a fluid leak from the fluid supply package is detected.

The fluid dispensing valve may otherwise be configured to improve performance of the fluid supply package with which it is associated. For example, a fluid dispensing valve having a larger valve coefficient may be employed to enable greater flow rate or improved deliverables from the fluid supply package. A tied diaphragm could be employed to ensure that the valve seat is fully opened and not restricting flow of dispensed fluid. A reduction of the surface/volume ratio within the valve may be employed to result in a cleaner valve after the valve is cyclically purged. As another alternative feature, the sealing surface of the vessel outlet of the fluid supply package may be provided with a replaceable sealing surface element that can be replaced when the sealing surface is damaged or worn out, thereby ensuring a satisfactory seal, and extending the life of the fluid dispensing assembly that is engaged with the vessel outlet of the fluid supply package.

FIG. 3 is a schematic perspective view of a leak preventer valve assembly 40 according to one embodiment of the disclosure. The leak preventer valve assembly 40 includes a generally cylindrical body 46, and includes a distal coupling 42 and a proximal coupling 44, at the respective ends of the generally cylindrical body. A leak prevention valve is contained in the generally cylindrical body, and serves to prevent leakage of fluid from the vessel, in the event of damage or deterioration of the valve in the valve head that would otherwise result in fluid leakage from the fluid supply package. In various embodiments, the leak preventer valve assembly may include a check valve in the generally cylindrical body, and the proximal and distal couplings may comprise VCR fittings, or other coupling structure, for engagement of the leak preventer valve assembly in the fluid dispensing flow path in the fluid supply package.

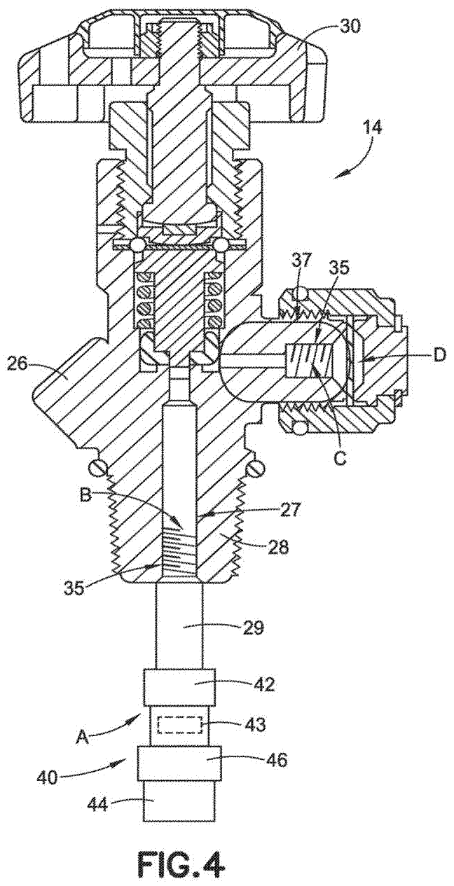

FIG. 4 is a cross-sectional elevation view of a fluid dispensing assembly of a type as may be employed in the fluid supply package of FIG. 1, showing installation positions for the leak preventer valve assembly. The reference numerals of the fluid dispensing assembly of FIG. 4 correspond to the same numbered parts and structure shown in FIGS. 1-3. The fluid dispensing assembly in FIG. 4 differs from that shown in FIG. 2 in the provision of a fluid discharge inlet conduit extending downwardly from the valve body coupling section 28 of the valve head 26. Such fluid discharge inlet conduit is open at its lower end, to allow ingress of fluid for discharge from the vessel through the associated fluid flow path to the fluid dispensing outlet port 32 (see FIGS. 1 and 2).

In various embodiments, the leak preventer shown in FIG. 3 can be deployed at various positions in the gas discharge flow path, as illustratively shown in FIG. 4. Thus, for example, the leak preventer valve assembly may be coupled to or otherwise arranged in-line in the fluid discharge inlet conduit depending downwardly from the valve body coupling section 28, e.g., at position “A”. Alternatively, the leak preventer valve assembly could be disposed in the valve head 26, e.g., at a lower portion of the fluid discharge passage in the valve body coupling section 28, at position “B”. As another alternative, the leak preventer valve assembly could be disposed in the outlet section of the valve head, upstream of the fluid dispensing outlet port, at position “C”. As a still further alternative, the leak preventer valve assembly could be coupled to the fluid dispensing outlet port, at position “D”.

It will be recognized that there are many possible arrangements for the leak preventer valve assembly in the fluid dispensing flow path, to provide a safeguard against leakage of fluid through the valve seat or other valve structure of the flow control valve in the valve head of the fluid dispensing assembly.

In a further aspect, the disclosure relates to a fluid dispensing assembly for use in a fluid supply package in which the fluid dispensing assembly is coupled with a fluid supply vessel, the fluid dispensing assembly comprising a valve head including a fluid dispensing valve in a valve chamber therein communicating with valve head inlet and outlet passages, an actuator configured to translate the fluid dispensing valve between a fully closed and a fully open position, and a torque wrench integrated and operatively engageable with the actuator, the torque wrench disengaging once a set closing torque is achieved, and optionally being configured to provide an audible output signal, e.g., in the manner of a gas cap that ‘clicks’ and disengages once a set closing torque is achieved.

In various embodiments of such fluid dispensing assembly, the torque wrench is configured to be integrated with the actuator, e.g., hand wheel or automatic actuator, as a permanently attached or otherwise “built-in” component. In some embodiments, the torque wrench may be associated with a hand wheel actuator and configured so that it is re-positionable from an operating position in which a torque can be exerted on the hand wheel, to a non-operating storage position in which torque is not exerted on the hand wheel.

In various embodiments of the fluid dispensing assembly, the torque wrench may be configured so that it becomes freewheeling in character and incapable of applying torque, beyond a predetermined torque level.

Thus, the present disclosure relates in various embodiments to a fluid dispensing assembly including a valve, and an integral torque wrench mechanism. The fluid dispensing assembly may for example include a valve stem or hand wheel that is rotatable to modulate the position of a valve in the fluid dispensing assembly, in which the valve stem or hand wheel comprises an integrated torque wrench mechanism, or in which at least one torque wrench integrated with the valve stem or hand wheel is provided.

In one simple implementation, the fluid dispensing assembly includes a torque wrench that is integrated with a hand wheel of the fluid dispensing assembly, in which the torque wrench is constructed and arranged so that if a maximum torque is achieved, the torque wrench simply spins in place without enabling the user to apply any additional force to the hand wheel. In such manner, the application of excessive force to the valve stem and associated valve element is avoided. Preferably, a single torque wrench is provided for opening or closing of the valve in the fluid dispensing assembly, although the present disclosure contemplates the provision of multiple integrated torque wrenches for respective valve opening and closing operations of the valve in the valve head of the fluid supply package.

In one specific implementation, the torque wrench that may be articulated so as to allow a “foldaway” positioning while being engaged with the hand wheel or valve stem, so that the torque wrench may be continuously engaged with a hand wheel or valve stem, but storable in a folded-down or other non-use position. Such torque wrench may be permanently secured to the hand wheel or valve stem, e.g., by mechanical fasteners, or other securement, or it may be removably installed on the hand wheel or valve stem so as to be available during the initiation of fluid dispensing from an associated fluid storage and dispensing vessel, and at the cessation or termination of such dispensing operation.

Regardless of the torque wrench mechanism provided, the purpose of the torque wrench mechanism is to prevent the application of excessive force to the fluid dispensing assembly, so that the valve head and valve elements thereof are not deformed or otherwise damaged during modulation of the position of the valve, between fully opened and fully closed positions.

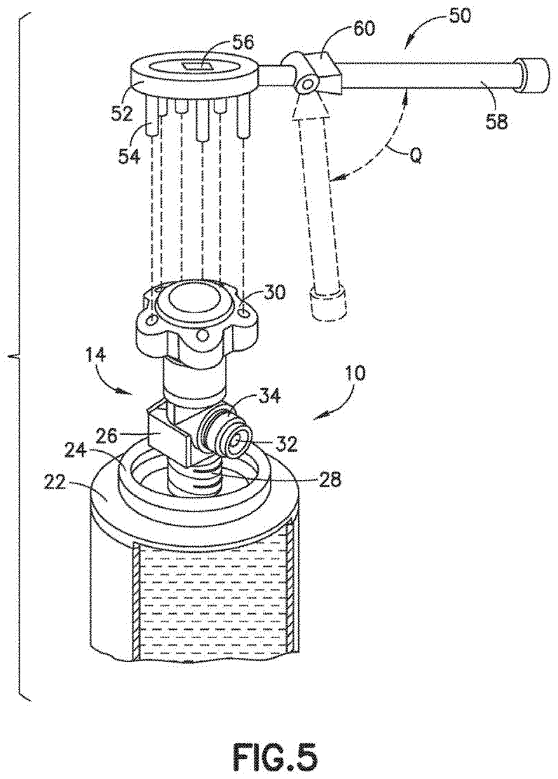

FIG. 5 is a perspective view of an upper portion of a fluid supply package of the type shown in FIG. 1, and a torque wrench integrated with the hand wheel of the fluid dispensing assembly, with a torque limit indicator display.

The reference numerals of the illustrated portion of the fluid supply package are correspondingly numbered to the same parts and structure of FIG. 1. The torque wrench 50 includes a torque wrench head 52 from which downwardly depends an array of hand wheel engagement tines 54, which are engageable with respective holes of the hand wheel so that torque wrenching action can be exerted on the hand wheel in either direction of rotation (clockwise or counterclockwise). The torque wrench head 52 is shown as having disposed on the top surface thereof a torque limit indicator display 56. The torque limit indicator display may comprise an indicator light that is switched on when maximum permissible torque is reached by the torque wrench, so that the hand wheel is not rotated past its respective fully open or fully closed limits.

The torque wrench 50 comprises a torque wrench handle 58 that in the embodiment shown is coupled with fold-down joint 60, so that the torque wrench in the operational position shown may be lowered in the direction indicated by the bidirectional arrow Q so that the torque wrench may be stored in such position (shown by the dashed line representation) on the fluid supply package, and then raised to the position shown in solid line representation, to effect rotation of the hand wheel in the desired manner.

The torque wrench is shown in FIG. 5 as engageable and disengageable from the hand wheel by respective insertion or removal of tines in the holes in the hand wheel, but it will be recognized that the torque wrench may be permanently secured to such hand wheel, to provide a unitary torque wrench and hand wheel assembly.

A further aspect of the disclosure relates to a fluid dispensing assembly for use in a fluid supply package in which the fluid dispensing assembly is coupled with a fluid supply vessel, the fluid dispensing assembly comprising a valve head including a fluid dispensing valve in a valve chamber therein communicating with valve head inlet and outlet passages, an actuator configured to translate the fluid dispensing valve between a fully closed and a fully open position, a cap configured to overlie the valve head and define therewith an enclosed volume, and adsorbent disposed in the enclosed volume and arranged to remove contaminating fluid leaking from the valve head into the enclosed volume. The fluid supply vessel in such package may be of any suitable type, including fluid supply vessels containing adsorbent as a storage medium for the fluid to be contained in and subsequently dispensed from the vessel, as well as fluid supply vessels having interiorly disposed therein pressure-regulating device(s) for controlled dispensing of fluid at desired pressure, as well as fluid supply vessels of other configurations.

Thus, a fluid dispensing assembly may be provided including a valve dust cap that is employed to overlie the valve head of a fluid dispensing assembly of a fluid supply package, so as to form an enclosed volume about the valve head, wherein adsorbent having sorptive affinity for the fluid in the fluid supply package is interiorly disposed in the cap so that it can sorptively remove leakages of the fluid that contaminate the enclosed volume. The adsorbent may be presented to the enclosed volume in the form of a film or layer comprising the adsorbent that is provided on an interior surface of the cap, e.g., with the adsorbent in a granular or otherwise particulate form dispersed in a binder or other film-forming material. Alternatively, the adsorbent may be provided in a package that is secured to the interior surface of the cap, and includes a permeable film or other access structure for contaminant gas in the interior volume to contact and be removed by the adsorbent.

In specific illustrative embodiments, the fluid in the fluid supply package may comprise boron trifluoride, and the adsorbent used to remove such fluid from the interior volume of the cap may comprise any one or more of calcium hydroxide, lithium hydroxide, iron oxide, copper sulfate, and/or any other materials that are sorptively effective to remove boron trifluoride contaminant from the enclosed interior volume of the cap. In other illustrative embodiments, the fluid in the fluid supply package may comprise phosphine, and the adsorbent utilized in the cap to remove contaminant quantities of such fluid may include any one or more of copper oxide, copper hydroxide, copper carbonate, copper hopcalyte, and impregnated carbons.

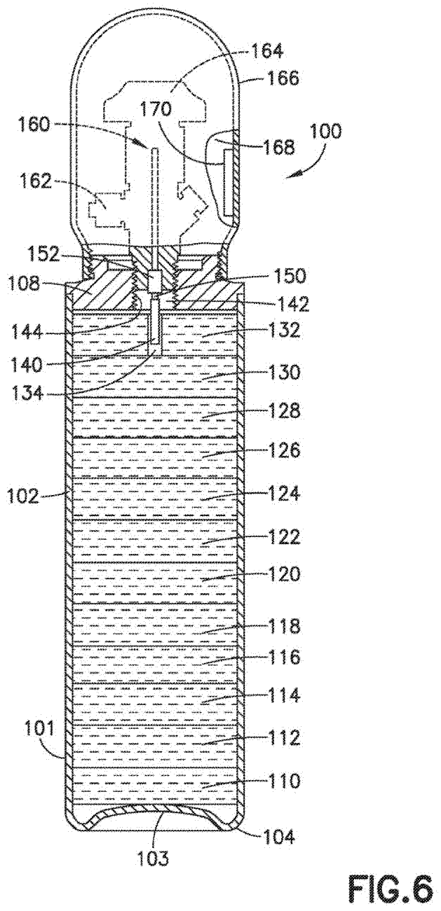

FIG. 6 is an elevation view, in partial section, of a fluid storage and dispensing system 100 utilizing a monolithic sorbent, according to a further aspect of the disclosure.

The system 100 includes a cylindrical fluid storage and dispensing vessel 101 having sidewall 102 and floor 103 enclosing an interior volume containing disk-shaped monolithic sorbent articles 110, 112, 114, 116, 118, 120, 122, 124, 126, 128, 130, and 132, stacked in face-to-face relationship to form the vertically extended composite body of sorbent articles within the vessel.

The floor 103 of the vessel 101 is as shown in FIG. 6 of a concave form, with an outer annular portion 104 serving to enclose an interior annular plenum volume that is devoid of sorbent material, and which thereby defines an interior annular space that is in communication with the space between the sidewall 102 and the adjacent stack of disk-shaped articles. The interior annular plenum volume thus permits disengaged (desorbed from the sorbent) or otherwise free gas to flow upwardly along the inner surface of the sidewall, for ultimate dispensing from the vessel.

In the vessel 101, the respective disk-shaped monolithic sorbent articles 110, 112, 114, 116, 118, 120, 122, 124, 126, 128, 130, and 132 may each be of a same diameter and thickness, with the exception that the uppermost monolithic sorbent article 132 has a central passage 134 therein, to accommodate the filter 140. As an alternative embodiment, multiple sorbent articles in the stock may be provided with a central passage, so that an elongate vertical passage is provided in the stack of sorbent articles, for a gas discharge tube. Such gas discharge tube may contain an in-line leak prevention valve assembly of a type as previously described. In specific embodiments, the gas discharge tube may be provided with openings along its length, so that desorbed gas under dispensing conditions can enter the gas discharge tube from sorbent articles that are stacked along the length of such tube.

At its top portion, the upper edges of the sidewall 102 are secured to a neck collar 108, e.g., by welding, brazing, or other suitable securement technique or structure. The neck collar 108 has a central opening 142 therein, communicating with central passage 134 of the uppermost monolithic sorbent article 132, and the central opening 142 has a threaded interior surface 144, with which the complementary threading of valve head 160 can be threadably engaged.

The valve head 160 includes a main valve body having a valve structure therein (not shown) with a threaded lower portion for engagement with the threaded interior surface 144 of the central opening 142 in a leak-tight manner. The valve head has interior passage(s) therein communicating with the dispense port 162, which may include a fitting threadably engaged with a passage opening in the valve head, for joining to external flow circuitry, to enable gas dispensing from the system 100. The valve head interior passage(s) also communicate with an inlet port of the valve head, in which is disposed the bushing 152 to which is joined feed tube 150 having filter 140 joined to its lower end.

By this arrangement, gas desorbed from the sorbent in the vessel 101 is flowed in the dispensing operation to the central passageway 134, enters the filter 140, flows through feed tube 150 and a central opening in the bushing 152, into the interior passage(s) of the valve head 160. The interior passage(s) of the valve head may be suitably formed to accommodate interaction with a stem assembly and valve element (not shown) that is translatable between a fully open and a fully closed position of the valve in the valve structure within the valve head 160. The stem assembly in turn is coupled with a valve actuator 164, which in the embodiment shown is a hand wheel for manual opening and closing of the valve, but which alternatively may comprise an automatic actuator, such as a solenoid actuator, pneumatic actuator, or the like, coupled to suitable actuating circuitry, power supplies, central processor units, etc.

The neck collar 108 at its upper neck portion has an exterior neck surface that is threaded to matably engage a dust cap 166 that is complementarily threaded on the lower interior surface of the cap. The cap encloses an interior volume 168, in which is disposed adsorbent 170. Consistent with the preceding discussion herein, the adsorbent 170 may be provided as a layer or deposit on interior surface area of the cap, such as in a binder in which the adsorbent is sorptively available, or the adsorbent may be provided in a container that is permeable to fluid that may leak from the vessel and enter the cap's interior volume. For example, the adsorbent 170 may include adsorbent particles packaged in a film container that is permeable to the fluid for which the adsorbent is selective. The adsorbent 170 is selected to have sorptive affinity for the fluid contained in container 101, so that any leakage into the interior volume 168 of the cap 166 is taken up by the adsorbent. Although shown as a localized provision of adsorbent, the adsorbent may be coated on all or a substantial portion of the interior surface of the interior volume of the cap 166, e.g., in a thin-film binder that is applied to the cap's interior surface.

The cap in this manner serves to protect the valve head 160 from impact and environmental exposure, while at the same time removing any leakage from the vessel into the interior volume 168 in the cap 166. The cap can readily be unscrewed from the neck collar 108 to access the valve head for coupling to gas flow circuitry for the dispensing of fluid in the dispensing mode of the system 100.

The dispensing of gas from the vessel 101 may be carried out in any appropriate mode of operation. For example, the valve head 160 may be coupled with gas flow circuitry to a semiconductor process tool or other gas-utilizing apparatus or site, with gas being desorbed under the impetus of a reduced pressure in the flow circuitry external of the vessel. Additionally, or alternatively, the vessel may be subjected to heating, e.g., by the installation of a heating jacket about the vessel, whereby the sorbent is heated to desorb gas therefrom for dispensing. As another alternative or additional mode of dispensing, an extraction system, e.g., an extraction pump, eductor, venturi, compressor, turbine, or other device effective to withdraw gas from the vessel, may be employed. In a still further embodiment, the vessel may be arranged so that a carrier fluid is flowed through the interior of the vessel 101, to establish a mass transfer gradient effecting desorption and entrainment of the desorbed fluid in the carrier gas, so that the desorbed fluid and carrier gas mixture then is discharged from the vessel in the dispensing operation.

By providing the sorbent medium in the vessel 101 in the form of monolithic disk-shaped articles in a stacked array as shown in FIG. 6, there is provided a highly compact arrangement in which substantially the full interior volume of the vessel 101, e.g., other than the interior annular space at the lower periphery of the interior volume of the vessel, and the central passage 134 of the uppermost monolithic sorbent article 132, is filled with sorbent. The monolithic sorbent articles can be made of a diameter that is closely proximate to the inner diameter of the vessel, so that there is a minimal clearance between the side edges of the monolithic sorbent articles and the interior sidewall surface of the vessel adjacent thereto, as sufficient to accommodate flow of gas from the sorbent along the sidewall to the upper portion of the vessel for dispensing.

The sorbent in the interior volume of the vessel 101 of FIG. 6 may be provided, as in the illustrated arrangement, by a stack of disk-shaped monolithic articles of sorbent material, or alternatively in other manner. For example, the sorbent may be provided as a unitary cylindrical monolithic article that is installed in the vessel prior to the securement of the neck collar to the upper edges of the sidewall 102. As another alternative, the sorbent may be formed in situ in the vessel interior volume.

A further aspect of the disclosure relates to a coupling alignment device including a body portion adapted to circumscribe respective coupling elements to be engaged with one another so that the coupling elements are axially aligned for engagement, and a positioning assembly operatively associated with the body portion and configured to position the coupling alignment device upon or subsequent to engagement of the respective coupling elements.

In various embodiments of such coupling alignment device, the body portion is of tubular form, and the positioning assembly comprises a spring-loaded mechanism for translating the coupling alignment device away from the coupling elements upon their engagement.

Accordingly, the fluid dispensing assembly may employ a spring-loaded device that ensures proper alignment of couplings in the connection of the fluid dispensing assembly to flow circuitry for delivering dispensed fluid to a downstream location or processing apparatus. The spring-loaded device may for example be configured as a short tube or cage structure, and as the fluid supply package approaches the fitting of the fluid dispensing assembly of the package, the fitting enters the tube or cage structure and fits snugly enough so that proper alignment is necessary, i.e., the fitting can enter the tube or cage structure only when the fluid discharge conduit of the fluid dispensing assembly is fully aligned with the tube or cage structure.

The alignment device then would be translatable to sufficient extent to allow the fluid supply package to be tightly coupled to the fitting. The action of the alignment device could be nonlinear in character, so that at the depth at which the threads are firmly engaged, the alignment device would pop out of the way or otherwise disengage from the locus of the coupling. For example, in one embodiment, the alignment device can translate backwardly in a linear manner toward the plane of the neck of the fluid supply package. In another illustrative embodiment, the alignment device can be circumferentially segmented, with the individual segments popping outwardly from the axis of the fitting, in the manner of wings. The alignment device also serves to protect the sealing surfaces of the fluid supply package from incidental contact and damage.

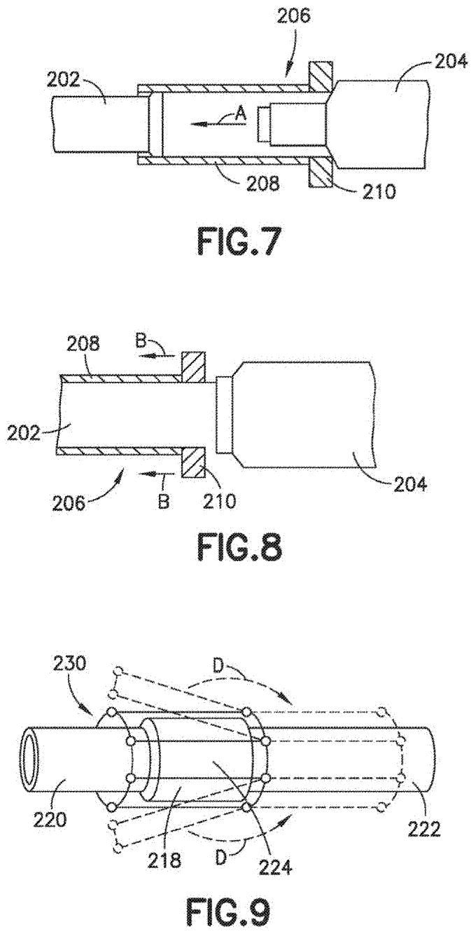

FIG. 7 is a partial sectional side elevation view of a coupling alignment device 206 according to one aspect of the disclosure, as associated with couplings 202 and 204 to be engaged with one another. The coupling alignment device 206 includes a tubular alignment guide member 208, shown in cross-section in the view is shown, as associated with a spring-loaded assembly in the base 210 of the device. The couplings 202 and 204 are engaged with one another, by forward translation of the coupling 204 in the direction indicated by arrow A.

FIG. 8 is a partial sectional side elevation view of the coupling alignment device and couplings of FIG. 7, when the couplings have been fully engaged with one another.

When the couplings are manually engaged, as shown in FIG. 8, pressure is exerted on the base 210 of the coupling alignment device, causing the spring-loaded assembly in the base 210 of the device to be actuated and to translate the coupling alignment device 206 in the direction indicated by arrows B in FIG. 8. Thus, the coupling alignment device ensures that the couplings 202 and 204 are properly axially aligned with one another, so that the sealing surfaces and any associated threading or engagement members in the couplings are not script, scored, or otherwise damaged as a result of misalignment of the couplings.

FIG. 9 is a perspective view of a coupling alignment device 230 according to a further embodiment, as associated with couplings 218 and 224 engaged with the assistance of such device. The coupling 218 is associated with a fluid discharge conduit of a fluid dispensing assembly associated with a fluid supply package, and coupling 224 is associated with a flow circuitry conduit 222 for delivery of the dispensed fluid to a downstream locus, such as to a process tool or other location of use. The coupling alignment device 230 is shown as including a circumferentially enclosing cage structure made up of circumferentially adjacent cage segments. For simplicity, the actuating assembly associated with such coupling alignment device has been omitted, but acts when the coupling has been affected and the respective coupling elements have been axially guided into engagement with one another, to cause the circumferentially adjacent cage segments to pivot on their hinge joints so that they move from a forwardly extended position through the arc D as illustrated in FIG. 9 to a rearwardly retracted position as shown in dashed line representation in such figure.

It will be recognized that such cage structure may be actuated with an associated actuating assembly, in any suitable manner, and that other variations of such coupling alignment device are possible in which the device remains in place surrounding the coupling so that when they are disengaged, no oblique or off-center movements of the couplings pose a risk of damage in the disengagement of the coupling elements.

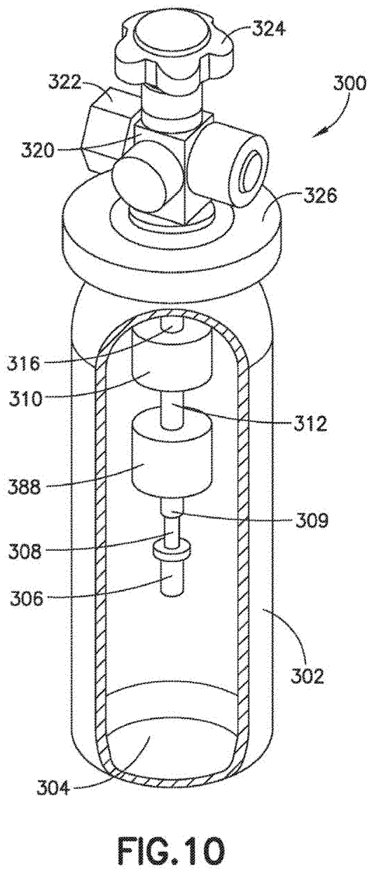

FIG. 10 is a perspective view, in partial section, of a pressure-regulated fluid supply package 300 in accordance with one aspect of the present disclosure.

The fluid supply package 300 includes a vessel 302 defining an enclosed interior volume 304. The vessel 302 at its upper end is coupled with a flange 326, which in turn is coupled with the valve head 320, containing a valve element in a valve chamber communicating with the interior volume 304 of the vessel 302 and with the gas discharge port 322 of the package. The valve element is coupled with actuator 324, which may comprise a manual hand wheel, as shown, or alternatively a manual actuator of other type, or alternatively an automatic actuator of any suitable type.

The package 300 in vessel 302 holds an interior pressure-regulating assembly including a series-connected arrangement of pressure regulators 388 and 310 interconnected by a check valve 312. Pressure regulator 388 in turn may be connected to an upstream check valve 309, connected in turn by gas inlet tube 308 to a filter 306. The filter 306 may comprise a sintered matrix or other filter element, for the purpose of preventing particulates from entering the gas discharge path including tube 308, check valve 309, pressure regulator 388, check valve 312, pressure regulator 310, and check valve 316 connected with the valve head 320.

The regulators 388 and 310 may be of a set point regulator type, in which the lower pressure regulator 388 has a higher set point pressure, and in which the upper pressure regulator 310 has a lower set point pressure, wherein the respective set point pressures are provided to ensure dispensing of gas from the vessel in gas dispensing port 322 at a desired pressure condition.

It will be recognized that the gas supply vessel of FIG. 10 may be configured with only one of the check valves 309, 312, and 316, or with two of such check valves, or with all three of such check valves, as a leak preventer feature of the vessel, in various embodiments thereof.

A pressure-regulated fluid supply package is thus contemplated, as including a an interior fluid delivery assembly configured to deliver fluid from the vessel to a fluid dispensing assembly for dispensing of fluid from the package at a discharge port, in which the interior fluid delivery assembly defines a fluid flow path and includes at least one device configured to regulate flow of the fluid from the vessel to the discharge port, such device opening to fluid flow in response to pressure in the flow path downstream of the device that is below a set point pressure of the device, and at least one check valve upstream and/or downstream of the device, configured to prevent leakage of fluid through the device.

More generally, the present disclosure contemplates a wide variety of fluid supply packages comprising a fluid dispensing assembly of any suitable type as variously described herein, wherein the fluid dispensing assembly is coupled to a fluid supply vessel. In various embodiments, the fluid supply vessel may contain an adsorbent on which fluid is adsorbable, and from which fluid is desorbable under dispensing conditions of the fluid supply package. In other embodiments, a pressure regulating assembly may be interiorly disposed in the fluid supply vessel, and configured to dispense fluid for discharge from the fluid supply package at regulated pressure.

The fluid supply package, as variously described herein, may contain a fluid of any suitable type, e.g., a fluid for use in semiconductor manufacturing, such as a dopant fluid for ion implantation, or a fluid for vapor deposition and/or cleaning in a vapor deposition tool. The fluid may for example comprise a fluid selected from the group consisting of hydride fluids, halide fluids, and organometallic reagent fluids.

The disclosure further contemplates a semiconductor manufacturing apparatus, comprising a fluid supply package of any suitable type as variously described herein. The semiconductor manufacturing apparatus may for example comprise an ion implantation apparatus, a vapor deposition tool, or other suitable apparatus.

In another aspect, the disclosure relates to a method of providing fluid for use, comprising packaging a fluid in a fluid supply package of any suitable type as variously described herein.

A further aspect of the disclosure relates to a method of providing fluid for use, comprising supplying the fluid for use in a fluid supply package of any suitable type as variously described herein.

While the disclosure has been set forth herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the disclosure as hereinafter claimed is intended to be broadly construed and interpreted, as including all such variations, modifications and alternative embodiments, within its spirit and scope.

1-30. (canceled)

31. A fluid dispensing assembly comprising:
a valve head including a fluid dispensing valve in a valve chamber therein with a dispensed fluid flow path in the valve head including a valve head inlet passage communicating with the valve chamber;
a fluid discharge passage communicating with the valve chamber and with a discharge port in the valve head;
an actuator configured to translate the fluid dispensing valve between a fully closed to a fully open position;
a built-in torque wrench attached to the actuator, the built-in torque wrench configured to prevent the actuator from exerting force on the fluid dispensing valve beyond the force required for effecting a fully closed or fully open condition in respective closing or opening operations of the fluid dispensing valve in the valve chamber; and
wherein the built-in torque wrench is integrated and operatively engageable with the actuator, the built-in torque wrench disengaging once a set closing torque is achieved, wherein the built-in torque wrench comprises a fold-down joint and a torque wrench handle coupled with the fold-down joint so that the built-in torque wrench is storable in a folded-down position when not in use.

32. The fluid dispensing assembly of claim 31, comprising a lock assembly configured to secure the fluid dispensing valve in the valve chamber in a fully closed condition when not in dispensing operation.

33. The fluid dispensing assembly of claim 31, comprising a cap configured to overlie the valve head and define therewith an enclosed volume, and adsorbent disposed in the enclosed volume and arranged to remove contaminating fluid leaking from the valve head into the enclosed volume.

34. The fluid dispensing assembly of claim 31, comprising a positional indicator configured to generate an output indicative of a closed or open condition of the fluid dispensing valve in the valve chamber.

35. The fluid dispensing assembly of claim 31 coupled to a fluid supply vessel.

36. The fluid dispensing assembly of claim 35, wherein the leak preventer valve assembly is disposed in a dispensing conduit communicating with the valve head inlet passage and extending into an interior volume of the fluid supply vessel coupled with the fluid dispensing assembly.

37. The fluid dispensing assembly of claim 36, further comprising a leak preventer valve assembly configured to prevent fluid leakage from the fluid supply vessel through the discharge port to an ambient environment.
